(19) United States
(12) Patent Application Publication
(10) Pub. No.: US 2024/0396074 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Takenori IKEDA, Owariasahi-shi (JP); Tomoyuki UEZONO, Okazaki-shi (JP); Ryuta SUGIURA, Toyota-shi (JP); Takeshi ABE, Okazaki-shi (JP); Yuki TAKAHASHI, Miyoshi-shi (JP); Kenta KIMURA, Toyota-shi (JP)

(73) Assignee: TOYOTA JIDOSHA KABUSHIKI KAISHA, Toyota-shi (JP)

(21) Appl. No.: 18/636,985

(22) Filed: Apr. 16, 2024

(30) Foreign Application Priority Data
May 22, 2023 (JP) 2023-083962

(51) Int. Cl. H01M 10/04

(52) U.S. Cl. CPC H01M 10/0431; H01M 10/0422

(57) ABSTRACT

A power storage cell includes: an electrode assembly that includes a positive electrode sheet, a negative electrode sheet, and a separator, and is constructed as a wound body in which the positive electrode sheet and the negative electrode sheet are wound with the separator interposed therebetween; and a cell case that houses the electrode assembly. The cell case includes a cylindrical portion that surrounds an outer circumferential surface of the electrode assembly. The electrode assembly includes a pair of end regions including an end portion of the electrode assembly in an axial direction of the electrode assembly, and an intermediate region lying between the pair of end regions in the axial direction. A diameter of the intermediate region is larger than a diameter of the end region.

### CROSS REFERENCE TO RELATED APPLICATIONS

This nonprovisional application is based on Japanese Patent Application No. 2023-083962 filed on May 22, 2023 with the Japan Patent Office, the entire contents of which are hereby incorporated by reference.

### BACKGROUND

### Field

The present disclosure relates to power storage cells.

### Description of the Background Art

WO 2019/194182 discloses a cylindrical battery made up of a wound electrode assembly including a positive electrode plate and a negative electrode plate that are wound in a spiral with a separator interposed therebetween, an exterior can that houses the electrode assembly, and a nonaqueous electrolyte housed in the exterior can.

### SUMMARY

In the cylindrical battery described in WO 2019/194182, the electrode assembly expands during charging and discharging for example, and particularly a middle portion of a cylindrical portion of the exterior can expands accordingly. In such a state where the exterior can has expanded, stress larger than that occurring on the middle portion of the electrode assembly is caused on an end portion of the electrode assembly.

An object of the present disclosure is to provide a power storage cell that can inhibit nonuniform distribution of the stress caused on an electrode assembly when the electrode assembly expands.

A power storage cell according to an aspect of the present disclosure includes: an electrode assembly that includes a positive electrode sheet, a negative electrode sheet, and a separator, and is constructed as a wound body in which the positive electrode sheet and the negative electrode sheet are wound with the separator interposed therebetween; and a cell case that houses the electrode assembly. The cell case includes a cylindrical portion that surrounds an outer circumferential surface of the electrode assembly, the electrode assembly includes a pair of end regions including an end portion of the electrode assembly in an axial direction of the electrode assembly, and an intermediate region lying between the pair of end regions in the axial direction, and a diameter of the intermediate region is larger than a diameter of the end region.

A power storage cell according to another aspect of the present disclosure includes: an electrode assembly that includes a positive electrode sheet, a negative electrode sheet, and a separator, and is constructed as a wound body in which the positive electrode sheet and the negative electrode sheet are wound with the separator interposed therebetween; and a cell case that houses the electrode assembly. The cell case includes a cylindrical portion that surrounds an outer circumferential surface of the electrode assembly, the electrode assembly includes a pair of end regions including an end portion of the electrode assembly in an axial direction of the electrode assembly, and an intermediate region lying between the pair of end regions in the axial direction, and a density of the intermediate region is larger than a density of the end region.

The foregoing and other objects, features, aspects, and advantages of the present disclosure will become apparent from the following detailed description on the present disclosure, which will be understood with reference to the accompanying drawings.

### BRIEF DESCRIPTION OF THE DRAWINGS

FIG. 1 is a perspective view that schematically illustrates a power storage cell according to an embodiment of the present disclosure.

FIG. 2 is a front view of an electrode assembly constructed as a wound body.

FIG. 3 is a plan view that schematically illustrates a positive electrode sheet before it is wound.

FIG. 4 is a cross-sectional view along line IV-IV in FIG. 3.

FIG. 5 is a cross-sectional view that schematically illustrates a positive electrode current collector foil connected to an external terminal with a positive electrode current collector plate interposed therebetween.

FIG. 6 is a cross-sectional view that schematically illustrates the positive electrode current collector foil connected to the external terminal with a lead tab interposed therebetween.

FIG. 7 is a cross-sectional view along line VII-VII in FIG. 3.

FIG. 8 is a cross-sectional view along line VIII-VIII in FIG. 3.

FIG. 9 is a cross-sectional view that schematically illustrates a variation of the electrode assembly.

FIG. 10 is a cross-sectional view that schematically illustrates a variation of the electrode assembly.

FIG. 11 is a cross-sectional view that schematically illustrates a variation of the electrode assembly.

### DESCRIPTION OF THE PREFERRED EMBODIMENTS

Embodiments of the present disclosure are described with reference to the drawings. In the drawings referred to below, the same reference numerals are given to identical or equivalent members.

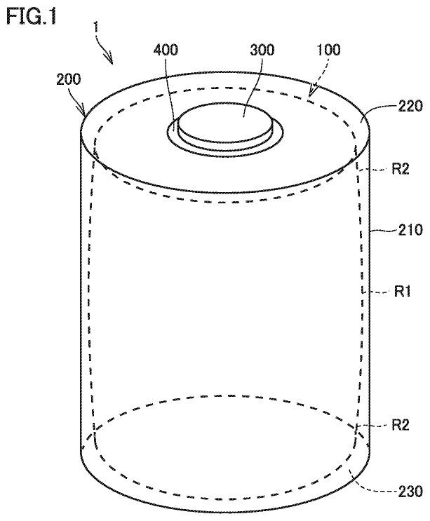

FIG. 1 is a perspective view that schematically illustrates a power storage cell 1 according to an embodiment of the present disclosure. Power storage cell 1 is preferably mounted on a vehicle.

As illustrated in FIG. 1, power storage cell 1 includes an electrode assembly 100, a cell case 200, and an external terminal 300.

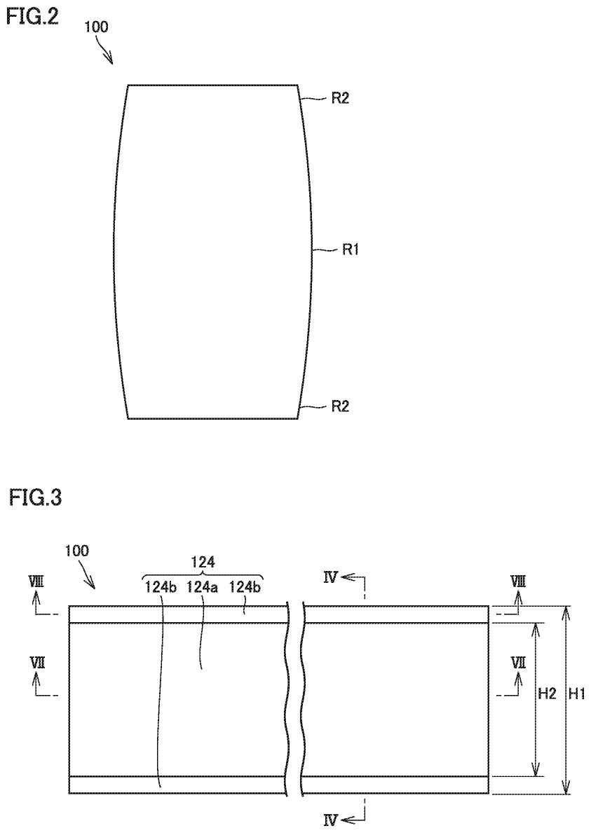

FIG. 2 is a front view of electrode assembly 100 (a wound body) before it is housed in cell case 200. As illustrated in FIG. 2, electrode assembly 100 includes a pair of end regions R2, which include an end portion of electrode assembly 100 in an axial direction (the longitudinal direction in FIG. 2) of electrode assembly 100, and an intermediate region R1, which lies between the pair of end regions R2. In the present embodiment, intermediate region R1 includes the middle of electrode assembly 100 in the axial direction. Thus, intermediate region R1 is hereinafter denoted as “middle region R1”. The diameter of middle region R1 is larger than the diameter of end region R2. That is, electrode assembly 100 has a shape where, in a state before it is housed in cell case 200, the middle portion in the axial direction expands more than the end portion in the axial direction. The length of middle region R1 in the axial direction may be set so as to be approximately 80% of the length of electrode assembly 100 in the axial direction.

Cell case 200 houses electrode assembly 100. In cell case 200, an electrolyte solution is also housed. Cell case 200 is hermetically sealed. Cell case 200 includes a cylindrical portion 210, a top wall 220, and a bottom wall 230. Cylindrical portion 210 surrounds the outer circumferential surface of electrode assembly 100. Top wall 220 is connected to an upper end portion of cylindrical portion 210. In a central portion of top wall 220, a through hole is formed, in which external terminal 300 is inserted. Bottom wall 230 is connected to a lower end portion of cylindrical portion 210.

External terminal 300 is fixed to top wall 220 with an insulation member 400 interposed therebetween. In the present embodiment, external terminal 300 forms a positive electrode external terminal. Cell case 200 forms a negative electrode external terminal.

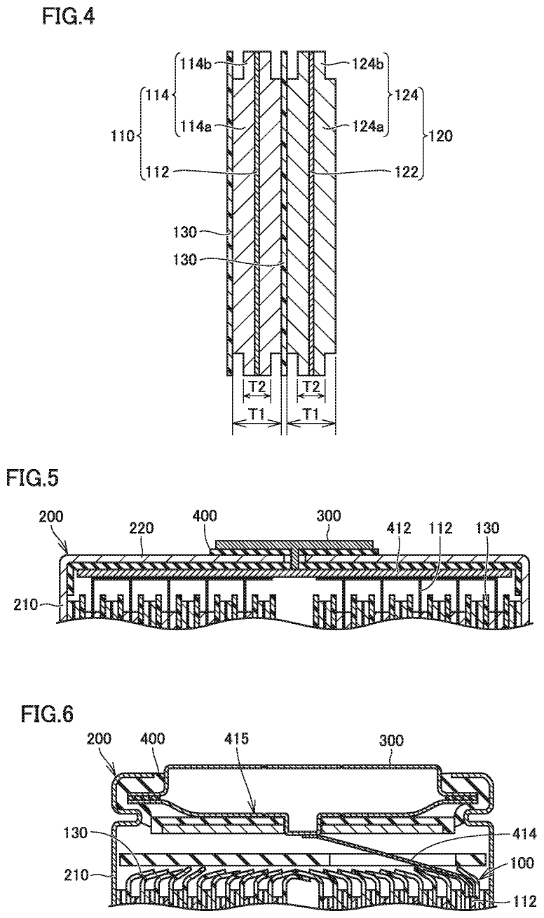

As illustrated in FIGS. 3 and 4, electrode assembly 100 includes a positive electrode sheet 110, a negative electrode sheet 120, and a separator 130. Electrode assembly 100 is constructed as a wound body in which positive electrode sheet 110 and negative electrode sheet 120 are wound with separator 130 interposed therebetween.

As illustrated in FIG. 4, positive electrode sheet 110 includes a positive electrode current collector foil 112 and a positive electrode active material layer 114.

Positive electrode current collector foil 112 is made of metal such as aluminum. Positive electrode current collector foil 112 is shaped like a rectangle long in length. Positive electrode current collector foil 112 is connected to external terminal 300 with a positive electrode current collector member interposed therebetween. For example, as illustrated in FIG. 5, an upper region of positive electrode current collector foil 112 (a region where positive electrode active material layer 114 is not provided) bends inward in a radial direction of electrode assembly 100 and the region bending inward may be connected to external terminal 300 with a positive electrode current collector plate 412 as the positive electrode current collector member interposed therebetween. For another example, as illustrated in FIG. 6, positive electrode current collector foil 112 may be connected to external terminal 300 with a lead tab 414 as the positive electrode current collector member interposed therebetween. In the example illustrated in FIG. 6, positive electrode current collector foil 112 is connected to external terminal 300 with lead tab 414 and a current interruption part 415 interposed therebetween.

Positive electrode active material layer 114 is provided on a surface of positive electrode current collector foil 112. As illustrated in FIG. 4, positive electrode active material layers 114 are provided on both surfaces of positive electrode current collector foil 112. Positive electrode active material layer 114 includes a middle active material portion 114a and an end active material portion 114b.

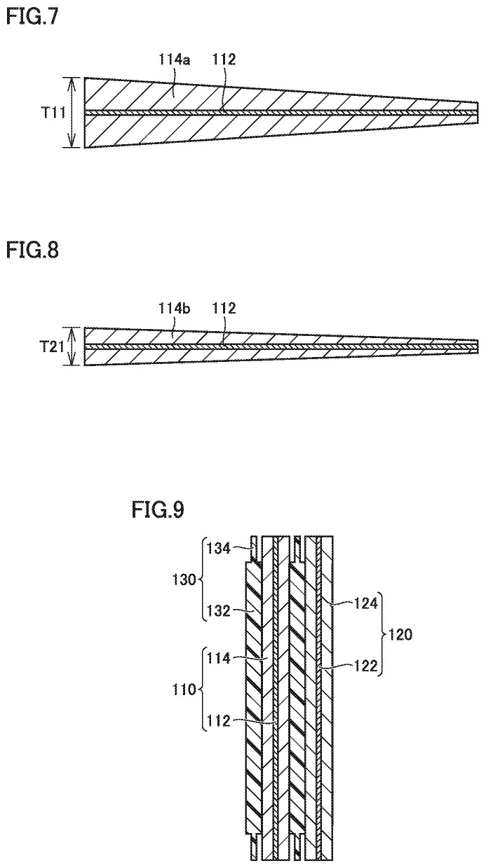

Middle active material portion 114a lies in middle region R1. As illustrated in FIG. 7, middle active material portion 114a gradually increases in thickness from the inner side of the winding (the right side in FIG. 7) toward the outer side of the winding (the left side in FIG. 7). In FIG. 7, negative electrode sheet 120 is not illustrated.

End active material portion 114b lies in end region R2. That is, end active material portions 114b lie outside middle active material portion 114a in the axial direction. As illustrated in FIG. 8, end active material portion 114b gradually increases in thickness from the inner side of the winding toward the outer side of the winding. In FIG. 8, negative electrode sheet 120 is not illustrated. As illustrated in FIGS. 7 and 8, a thickness T11 of middle active material portion 114a in an end portion on the outer side of the winding is larger than a thickness T21 of end active material portion 114b in an end portion on the outer side of the winding.

In a planar cross section of electrode assembly 100 (for example, the cross section illustrated in FIG. 4), which includes the central axis of electrode assembly 100, a thickness T1 of middle active material portion 114a is larger than a thickness T2 of end active material portion 114b. Thickness T1 of middle active material portion 114a may be set so as to be approximately 1.1 to 1.2 times as large as thickness T2 of end active material portion 114b.

As illustrated in FIG. 4, negative electrode sheet 120 includes a negative electrode current collector foil 122 and a negative electrode active material layer 124.

Negative electrode current collector foil 122 is made of metal such as copper. Negative electrode current collector foil 122 is shaped like a rectangle long in length. Negative electrode current collector foil 122 is connected to bottom wall 230 of cell case 200 with a negative electrode current collector member (not illustrated) interposed therebetween, which is similar to the positive electrode current collector member.

Negative electrode active material layer 124 is provided on a surface of negative electrode current collector foil 122. As illustrated in FIG. 4, negative electrode active material layers 124 are provided on both surfaces of negative electrode current collector foil 122. Negative electrode active material layer 124 includes a middle active material portion 124a and an end active material portion 124b.

Middle active material portion 124a lies in middle region R1. End active material portion 124b lies in end region R2. In a planar cross section of electrode assembly 100, which includes the central axis of electrode assembly 100, a thickness T1 of middle active material portion 124a is larger than a thickness T2 of end active material portion 124b. Thickness T1 of middle active material portion 124a may be set so as to be approximately 1.1 to 1.2 times as large as thickness T2 of end active material portion 124b. Thickness T1 of middle active material portion 124a may be different from thickness T1 of middle active material portion 114a of positive electrode active material layer 114. End active material portion 124b is preferably made from, for example, a Si-based material such as SiO, Si/C, or SiO/C. As the Si-based material, at least one of Si—X and Si—X/C is preferably used.

In a planar cross section of electrode assembly 100, which includes the central axis of electrode assembly 100, only one of thickness T1 of middle active material portion 114a of positive electrode active material layer 114 and thickness T1 of middle active material portion 124a of negative electrode active material layer 124 may be larger than respective thicknesses T2 of end active material portions 114b and 124b.

As illustrated in FIG. 4 for example, separator 130 is arranged between positive electrode sheet 110 and negative electrode sheet 120. More specifically, separator 130 is arranged between positive electrode active material layer 114 and negative electrode active material layer 124 that are adjacent to each other in the radial direction. Separator 130 is made from an insulation material and allows ions to pass therethrough.

As described above, in power storage cell 1 of the present embodiment, when electrode assembly 100 expands during charging and discharging for example, cylindrical portion 210 of cell case 200 expands accordingly. However, the diameter of middle region R1 is larger than the diameter of end region R2 in electrode assembly 100, and thus, nonuniform distribution of the stress caused on electrode assembly 100 when electrode assembly 100 expands is inhibited.

In addition, end active material portion 124b, which receives larger restraining force from cylindrical portion 210 during the expansion of electrode assembly 100 than the restraining force that middle active material portion 124a receives, is made from a Si-based material. Thus, energy density can be increased while inhibiting the expansion of end active material portion 124b.

In the above-described embodiment, as illustrated in FIG. 9, the respective thicknesses of active material layers 114 and 124 may be made uniform along the axial direction of electrode assembly 100. In this case, separator 130 includes a middle element 132, which lies in middle region R1, and an end element 134, which lies in end region R2, and the thickness of middle element 132 is made larger than the thickness of end element 134.

Further, in the above-described embodiment, the density of middle region R1 may be made larger than the density of end region R2 in electrode assembly 100. In this case, the diameter of middle region R1 may be made equal to the diameter of end region R2 or, as in the above-described embodiment, may be made larger than the diameter of end region R2.

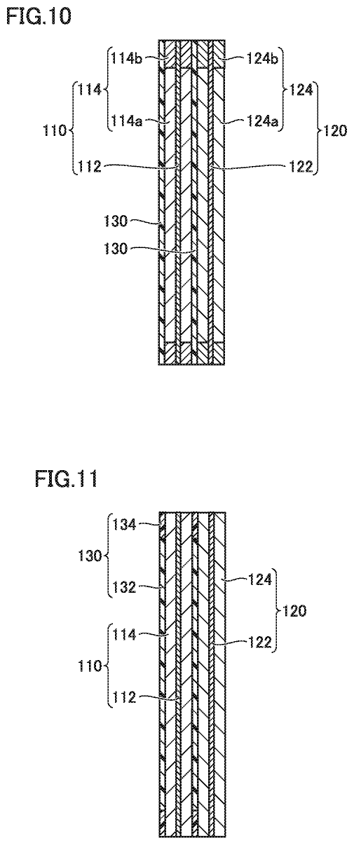

For example, the respective densities of middle active material portions 114a and 124a may be set so as to be larger than the respective densities of end active material portions 114b and 124b. In this case, end active material portions 114b and 124b may be made from a material different from the material from which middle active material portions 114a and 124a are each made. In this case, as illustrated in FIG. 10, the respective thicknesses of middle active material portions 114a and 124a may be made equal to the respective thicknesses of end active material portions 114b and 124b.

For another example, as illustrated in FIG. 11, the density of middle element 132 may be made larger than the density of end element 134 in separator 130. The density of middle element 132 can be adjusted by, for instance, a binder or the like being applied to middle element 132.

Moreover, although the above-described embodiment presents an example in which middle region R1 includes the middle of electrode assembly 100 in the axial direction, middle region R1 may be a region that does not include the middle of electrode assembly 100 in the axial direction (between the middle of electrode assembly 100 and end region R2 thereof in the axial direction).

Those skilled in the art will understand that the above-described exemplary embodiments are specific examples of the following aspects.

[Aspect 1]

A power storage cell comprising:
an electrode assembly that includes a positive electrode sheet, a negative electrode sheet, and a separator, and is constructed as a wound body in which the positive electrode sheet and the negative electrode sheet are wound with the separator interposed therebetween; and
a cell case that houses the electrode assembly, wherein
the cell case includes a cylindrical portion that surrounds an outer circumferential surface of the electrode assembly,
the electrode assembly includes
   a pair of end regions including an end portion of the electrode assembly in an axial direction of the electrode assembly, and
   an intermediate region lying between the pair of end regions in the axial direction, and
a diameter of the intermediate region is larger than a diameter of the end region.

In the power storage cell, when the electrode assembly expands during charging and discharging for example, the cylindrical portion of the cell case expands accordingly. However, the diameter of the middle region is larger than the diameter of the end region in the electrode assembly, and thus, nonuniform distribution of the stress caused on the electrode assembly when the electrode assembly expands is inhibited.

[Aspect 2]

The power storage cell according to aspect 1, wherein the intermediate region includes a middle of the electrode assembly in the axial direction.

[Aspect 3]

The power storage cell according to aspect 1 or 2, wherein
each of the positive electrode sheet and the negative electrode sheet includes
   a current collector foil, and
   an active material layer provided on a surface of the current collector foil
the active material layer includes
   a middle active material portion lying in the intermediate region, and
   an end active material portion lying in the end region, and
in a planar cross section of the electrode assembly, the cross section including a central axis of the electrode assembly, at least one of respective thicknesses of the middle active material portion of the positive electrode sheet and the middle active material portion of the negative electrode sheet is larger than a thickness of the end active material portion.

According to this aspect, the capacity of the electrode assembly is increased and nonuniform distribution of the stress caused on the electrode assembly when the electrode assembly expands is inhibited.

[Aspect 4]

A power storage cell comprising:
an electrode assembly that includes a positive electrode sheet, a negative electrode sheet, and a separator, and is constructed as a wound body in which the positive electrode sheet and the negative electrode sheet are wound with the separator interposed therebetween; and
a cell case that houses the electrode assembly, wherein
the cell case includes a cylindrical portion that surrounds an outer circumferential surface of the electrode assembly,
the electrode assembly includes
   a pair of end regions including an end portion of the electrode assembly in an axial direction of the electrode assembly, and
   an intermediate region lying between the pair of end regions in the axial direction, and
a density of the intermediate region is larger than a density of the end region.

[Aspect 5]

The power storage cell according to aspect 4, wherein the intermediate region includes a middle of the electrode assembly in the axial direction.

[Aspect 6]

The power storage cell according to aspect 4 or 5, wherein
each of the positive electrode sheet and the negative electrode sheet includes
   a current collector foil, and
   an active material layer provided on a surface of the current collector foil
the active material layer includes
   a middle active material portion lying in the intermediate region, and
   an end active material portion lying in the end region, and
a density of the middle active material portion is larger than a density of the end active material portion.

[Aspect 7]

The power storage cell according to aspect 6, wherein the end active material portion is made from a material different from a material from which the middle active material portion is made.

[Aspect 8]

The power storage cell according to any one of aspects 3, 6, and 7, wherein the active material layer gradually increases in thickness from an inner side of winding toward an outer side of the winding.

Although embodiments of the present disclosure have been described, it should be understood that the herein-disclosed embodiments are presented by way of illustration and example in every respect and are not to be taken by way of limitation. The scope of the present disclosure is defined by the claims and intended to include all changes within the purport and scope equivalent to the claims.

What is claimed is:

1. A power storage cell comprising:
an electrode assembly that includes a positive electrode sheet, a negative electrode sheet, and a separator, and is constructed as a wound body in which the positive electrode sheet and the negative electrode sheet are wound with the separator interposed therebetween; and
a cell case that houses the electrode assembly, wherein
the cell case includes a cylindrical portion that surrounds an outer circumferential surface of the electrode assembly,
the electrode assembly includes
a pair of end regions including an end portion of the electrode assembly in an axial direction of the electrode assembly, and
an intermediate region lying between the pair of end regions in the axial direction, and
a diameter of the intermediate region is larger than a diameter of the end region.

2. The power storage cell according to claim 1, wherein the intermediate region includes a middle of the electrode assembly in the axial direction.

3. The power storage cell according to claim 1, wherein
each of the positive electrode sheet and the negative electrode sheet includes
a current collector foil, and
an active material layer provided on a surface of the current collector foil,
the active material layer includes
a middle active material portion lying in the intermediate region, and
an end active material portion lying in the end region, and
in a planar cross section of the electrode assembly, the cross section including a central axis of the electrode assembly, at least one of respective thicknesses of the middle active material portion of the positive electrode sheet and the middle active material portion of the negative electrode sheet is larger than a thickness of the end active material portion.

4. A power storage cell comprising:
an electrode assembly that includes a positive electrode sheet, a negative electrode sheet, and a separator, and is constructed as a wound body in which the positive electrode sheet and the negative electrode sheet are wound with the separator interposed therebetween; and
a cell case that houses the electrode assembly, wherein
the cell case includes a cylindrical portion that surrounds an outer circumferential surface of the electrode assembly,
the electrode assembly includes
a pair of end regions including an end portion of the electrode assembly in an axial direction of the electrode assembly, and
an intermediate region lying between the pair of end regions in the axial direction, and
a density of the intermediate region is larger than a density of the end region.

5. The power storage cell according to claim 4, wherein the intermediate region includes a middle of the electrode assembly in the axial direction.

6. The power storage cell according to claim 4, wherein
each of the positive electrode sheet and the negative electrode sheet includes
a current collector foil, and
an active material layer provided on a surface of the current collector foil,
the active material layer includes
a middle active material portion lying in the intermediate region, and
an end active material portion lying in the end region, and
a density of the middle active material portion is larger than a density of the end active material portion.

7. The power storage cell according to claim 6, wherein the end active material portion is made from a material different from a material from which the middle active material portion is made.

8. The power storage cell according to claim 3, wherein the active material layer gradually increases in thickness from an inner side of winding toward an outer side of the winding.
